(19) United States
(12) Patent Application Publication
(10) Pub. No.: US 2002/0057058 A1
(43) Pub. Date: May 16, 2002

(54) High pressure discharge lamp and lighting apparatus using the lamp

(75) Inventors: Hisashi Honda, Yokosuka-shi (JP); Seiji Ashida, Yokosuka-shi (JP)

Correspondence Address: PILLSBURY WINTHROP LLP, 1600 TYSONS BOULEVARD, MCLEAN, VA, 22102, US

(73) Assignee: TOSHIBA LIGHTING & TECHNOLOGY CORPORATION, Tokyo (JP)

(21) Appl. No.: 09/960,943

(22) Filed: Sep. 25, 2001

(30) Foreign Application Priority Data
Sep. 28, 2000 (JP) 2000-297237
Jul. 13, 2001 (JP) 2001-214106

(51) Int. Cl. H01K 1/50

(52) U.S. Cl. 313/578

(57) ABSTRACT

A high pressure discharge lamp comprises an arc tube, and an outer bulb, enclosing the arc tube. The arc tube comprises a light-transmitting discharge vessel, made of ceramics, including a discharge space portion filled with an ionizable filling, and a pair of tube portions, of which inner diameter is smaller than that of the discharge space portion, continuously formed from the discharge space portion. Each of electrodes is arranged in the tube portions, wherein a minimum interspace between the outer surface of the electrode and the inner surface of the tube portion is 0.1 mm or less. A conductive member is arranged to at least one of the tube portions, and connected to the electrode of the other tube portion so as to have the same electrical potential.

### BACKGROUND OF THE INVENTION

1. Field of the Invention

The present invention relates to a high pressure discharge lamp, including a discharge vessel made of ceramics having light-transmitting characteristics, and a lighting apparatus using the lamp.

2. Description of the Related Art

Various high pressure discharge lamps have been developed in order to improve lamp life or efficiency. Recently, it has become possible to produce high pressure discharge lamps which are compact in size. Accordingly, such compact high pressure discharge lamps can be used for incandescent lamps, with a supply voltage ranging from 100 to 200 V.

Generally, it is necessary for high pressure discharge lamps to be supplied with a high pulse voltage of about 5 kV, generated by an igniter, when the high pressure discharge lamps start to light. A grow starter may be used for the igniter.

However, the need for a high pulse voltage to be supplied to the lamp prevents high pressure discharge lamps from being used as incandescent lamps. This is partly because sockets or distribution cables adapted for incandescent lamps cannot provide adequate electrical insulation against such a high pulse voltage. Furthermore, it is difficult for such compact high pressure discharge lamps to accommodate the igniter or glow starter.

Accordingly, it is desirable for such compact high pressure discharge lamps to have a lower starting voltage.

Japanese Laid Open Patent Application 2000-30663 (prior art 1) discloses a high pressure discharge lamp. Such a high pressure discharge lamp comprises an arc tube having small tube portions. Each of the electrodes is placed in one of the tube portions. A conductive member, as an aid starter, is wound around one of the tube portions. Furthermore, the electrode placed in the other tube portion is connected to the conductive member so as to have the same electrical potential.

Furthermore, Japanese Laid Open Patent Application 2001-167737 (prior art 2) discloses a high pressure discharge lamp. Such a high pressure discharge lamp comprises an arc tube having small tube portions. Each of the electrodes is placed in one of the tube portions. Conductive coils, as an aid starter, are wound on both tube portions. Furthermore, each of the electrodes is connected to the conductive coil on the opposite side from the electrode so as to have the same electrical potential.

Such a high pressure discharge lamp can have a reduced starting voltage. However, the reduced starting voltage value fluctuates due to temperature or brightness of atmosphere. Also, each of such high pressure discharge lamps has a different reduced starting voltage value. Particularly when such high pressure discharge lamps are used in environments of low temperature and brightness, the reduced starting voltage value tends to increase.

### SUMMARY OF THE INVENTION

According to one aspect of the invention, a high pressure discharge lamp comprises an arc tube, and an outer bulb, enclosing the arc tube. The arc tube comprises a light-transmitting discharge vessel, made of ceramics, including a discharge space portion filled with an ionizable filling, and a pair of tube portions, each of which has an inner diameter that is smaller than that of the discharge space portion, continuously fonned from the discharge space portion. Each of two electrodes are placed in opposite tube portions, wherein a minimum interspace between the outer surface of the electrode and the inner surface of the tube portion is 0.1 mm or less. A conductive member is arranged to at least one of the tube portions, and connected to the electrode of the other tube portion so as to have the same electrical potential.

According to another aspect of the invention, a lighting apparatus includes a housing, a high pressure discharge lamp described above, and an electronic ballast, including an inverter circuit, supplying a high frequency voltage of 10 to 200 kHz to the high pressure discharge lamp.

These and other aspects of the invention are further described in the following drawings and detailed description of the invention.

### BRIEF DESCRIPTION OF THE DRAWINGS

The invention will be described below in more detail by way of examples illustrated by drawings in which:

FIG. 1 is a front view, partly in longitudinal section, of a high pressure discharge lamp according to a first embodiment of the present invention;

FIG. 2 is an enlarged longitudinal section of the high pressure discharge lamp shown in FIG. 1;

FIG. 3 is a front view, partly in longitudinal section, of the high pressure discharge lamp without a lamp cap shown in FIG. 1;

FIG. 4(a) and 4(b) are histograms of the lamp starting voltage of Comparative sample 1, and 4(c) and 4(d) are histograms of the lamp starting voltage of Example 1 of the present invention;

FIG. 5(a) is a histogram of the lamp starting voltage of Comparative sample 2, and 5(b) is a histogram of the lamp starting voltage of Example 2 of the present invention;

FIG. 6 is a front view, partly in longitudinal section, of a high pressure discharge lamp according to a second embodiment of the present invention;

FIG. 7 is a front view, partly in longitudinal section, of a high pressure discharge lamp according to a third embodiment of the present invention;

FIG. 8 is an illustration of an enlarged longitudinal section of a high pressure discharge lamp according to a fourth embodiment of the present invention.

FIG. 9 is a front view, partly in longitudinal section, of a high pressure discharge lamp according to a fifth embodiment of the present invention;

FIG. 10 is a circuit diagram of an electronic ballast for a high pressure discharge lamp of the present invention.

FIG. 11 is an illustration of a longitudinal section of a spotlight according to a lighting apparatus of the present invention; and

FIG. 12 is a longitudinal section of a high pressure discharge lamp device according to a lighting apparatus of the present invention.

### DETAILED DESCRIPTION OF THE EMBODIMENTS

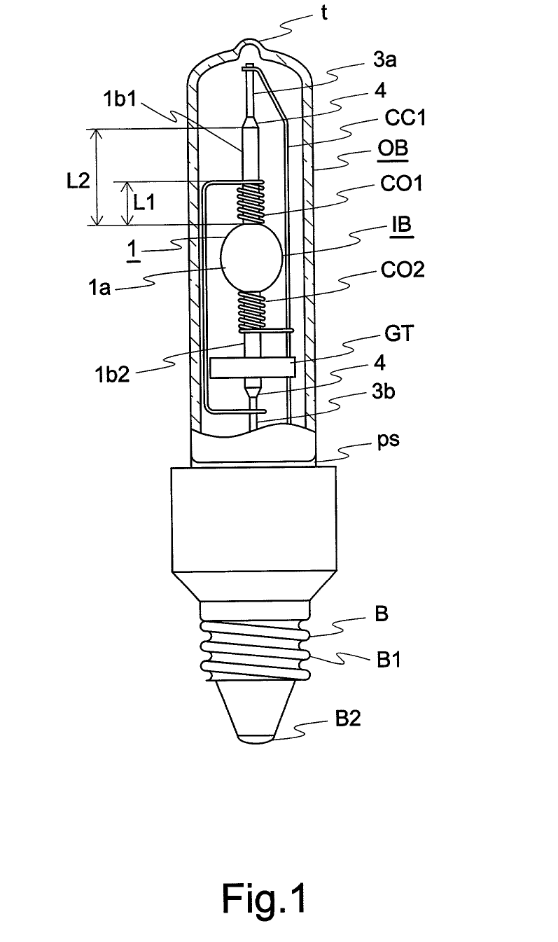

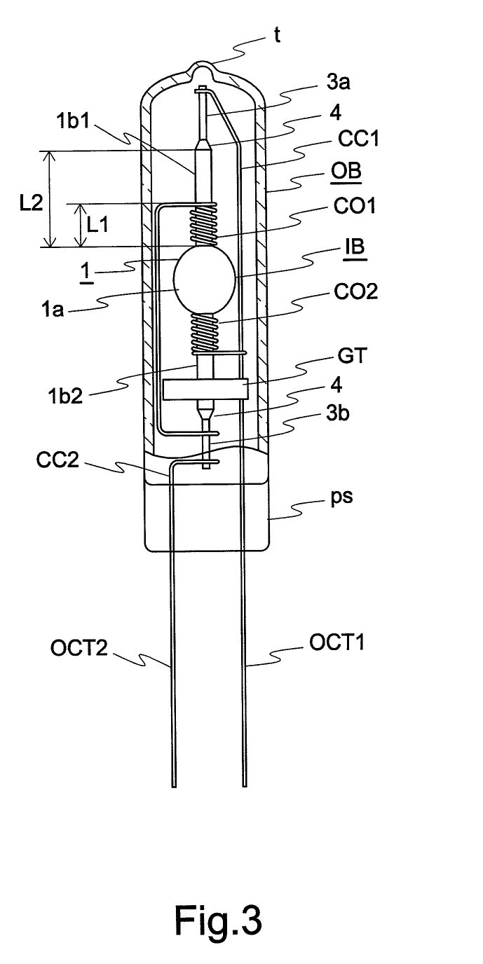

A first embodiment of the invention will be described in detail with reference to FIGS. 1 to 3. A high pressure discharge lamp, shown in FIG. 1, is provided with an arc tube IB, first and second connecting wires CC1, CC2, first and second coils CO1, CO2 as a conductive member, an outer bulb OB, a pair of lead wires OCT1, OCT2 extending from the outer bulb OB, a getter GT, and a lamp cap B.

The arc tube IB comprises a discharge vessel 1 made of a ceramic having light-transmitting characteristics, first and second electrodes 2A, 2B, first and second conductors 3a, 3b, a pair of sealing portions 4, 4, and an ionizable filling.

The discharge vessel 1 has a spherical-shaped portion 1a as a discharge space portion, and a pair of tube portions 1b1, 1b2, each inner diameter of which is smaller than an inner diameter of the spherical-shaped portion 1a, continuously formed from the spherical-shaped portion 1a.

The discharge space portion 1a of the discharge vessel 1 may be made of mono-crystalline metal oxide, e.g., sapphire, poly-crystalline metal oxide, e.g., alumina, yttrium aluminum garnet (YAG), yttrium oxide (YOX), or poly-crystalline non-metal oxide, e.g., aluminum nitride. At least discharge space portion 1a of the discharge vessel 1 may has light-transmitting characteristics. The pair of tube portions 1b1, 1b2 of the discharge vessel 1 may have light-shielding characteristics.

Furthermore, the volume of the discharge vessel 1 may be 0.06 cc or less, or be preferably 0.04 cc or less in order to fit into a compact high pressure discharge lamp. In this case, the discharge vessel 1 has a length of 35 mm or less, and preferably in the range of 10 mm to 30 mm.

Each of the first and second electrodes 2A, 2B is made of doped-tungsten, and includes an electrode rod 2a and a coil 2b wound to a tip portion of the electrode rod 2a. The electrode rod 2a is arranged in the first tube portion 1b1 with the tip portion of the electrode rod 2a projecting into the discharge space portion 1a. Furthermore, a minimum interspace (g) between the inner surface of the tube portion 1b1, 1b2 and the outer surface of the electrode 2A, 2B is 0.1 mm or less. In this case, the outer surface of the electrode 2A, 2B may contact the inner surface of the tube portion 1b1, 1b2. The interspace (g) is measured at the tube portion where the conductive member is placed.

Furthermore, the electrode rod 2a may have an inner-conductive coils MC1, MC2 in order to decrease the interspace (g). In the case of using an inner-conductive coil MC1, MC2, the interspace (g) is defined as the distance between the outer surface of the coil MC1, MC2 and the inner surface of the tube portion 1b1, 1b2. This interspace (g) may be 0.1 mm or less. In this case, the interspace (g) between the outer surface of the electrode rod and the inner surface of the tube portion may be over 0.1 mm. Also, the outer surface of the coil MC1, MC2 may contact the inner surface of the tube portion 1b1, 1b2. When the electrode 2A, 2B partly contacts the inner surface of the tube portion 1b1, 1b2, the starting voltage tends to be decreased.

The starting voltage of the high pressure discharge lamp is controlled by the discharge starting voltage between the conductive member and the electrode. The discharge starting voltage is considered to include a dielectric-breakdown voltage for a given tube portion thickness, and a discharge starting voltage at a minimum interspace (g).

When the interspace (g) is over 0.1 mm, excess of the metal halide and mercury reside in the interspace (g) in a liquid state. The excess of the metal halide and mercury may evaporate completely during the stable lighting of the lamp. When this occurs, the discharge starting voltage at the interspace (g) increases. As a result, the discharge starting voltage rises to over 5 kV. According to the invention, the discharge starting voltage at the interspace (g) can be decreased by controlling the interspace (g). Therefore, the starting voltage of the lamp may be reduced.

Each electrode 2A, 2B may be made of tungsten, and each tip of the electrodes 2A, 2B may be formed into a spherical shape. Moreover, the tip of the electrodes 2A, 2B may be located in the tube portions 1b1, 1b2.

Each of the conductors 3a, 3b, made of niobium, is formed into rod shape, connected to an opposite end of the tip portion of the electrodes 2A, 2B, and extend from the discharge vessel 1.

The conductors 3a, 3b may be made of tantalum, titanium, zirconium, hafnium, or vanadium. When the discharge vessel 1 is made of alumina, yttrium aluminum garnet (YAG), or yttrium oxide (YOX), it is suitable for the conductors 3a, 3b to be made of niobium and tantalum because the coefficient of thermal expansion of niobium and tantalum is similar to that of alumina, yttrium aluminum garnet (YAG), or yttrium oxide (YOX). When using aluminum nitride to make the discharge vessel 1, it is suitable for the conductors 3a, 3b to be made of zirconium. The conductors 3a, 3b may be formed into pipe or coil shape. Furthermore, each of the conductors 3a, 3b may be connected to the opposite end of the tip portion of the electrodes 2A, 2B via molybdenum, tungsten, or cermet made by mixing ceramics and metal.

A sealing compound for ceramics is melted by heating, applied to the sealing portion 4, the end surface of the tube portion 1b1, 1b2; and around the conductor 3a, 3b; including the connecting portion with the electrode 2A, 2B. Accordingly, the aforementioned connecting portion of the conductor 3a, 3b, located in the tube portion 1b1, 1b2, is also covered by the sealing compound 4.

The discharge vessel 1 is filled with an ionizable filling containing metal halide, mercury, and rare gases including neon and argon. When the high pressure discharge lamp stably lights, excess amounts of the metal halide and mercury reside in the interspace (g) in a liquid state. In this case, a cold spot of the lamp occurs at the surface of the liquid mixture of metal halide and mercury.

Aforementioned rare gases can control an amount of a glow discharge current of a glow discharge, and reduce a starting voltage. The mixture of rare gases, including neon and argon, may have a total pressure of 10.64 to 66.5 kPa in the discharge vessel, or preferably in the range of 13.3 to 26.6 kPa. In this case, argon gas may have a partial pressure of 0.1 to 15% of the total pressure, or preferably in the range of 0.1 to 10%.

When the total pressure of the rare gas mixture is over 66.5 kPa, the starting voltage tends to increase. When the total pressure of the rare gas mixture is less than 10.64 kPa, it takes a long time to transform a glow discharge to an arc discharge. Therefore, the electrode made of tungsten evaporates increasingly, so that a blackening of the discharge vessel start to occur. The glow discharge should be transformed to an arc discharge in a period ranging from 0.5 to 3 seconds in order not to blacken the discharge vessel. The period of the transformation is preferably in the range of 1.0 to 2.5 seconds. This period of transformation is measured from a start time of the grow discharge to a start time of the arc discharge. The start time of the arc discharge is the time when the wave form of the lamp voltage drops in an oscilloscope. In this case, after the period is measured five (5) times, the periods are averaged. If each of the electrodes has a different start time of the arc discharge, a long period is measured.

When the period of the transformation is under 0.5 seconds, much electrical power is consumed quickly, so that the electrodes heat excessively. Therefore, the electrodes evaporate increasingly, so that blackening of the discharge vessel occurs. When the period of the transformation is over 3.0 seconds, the electrodes evaporate significantly during that period. As a result, significant blackening occurs, so that the luminous flux maintenance factor starts to decrease. When the period is in the range of 0.5 to 3.0 seconds, the luminous flux maintenance factor can be kept 80% or more after the lamp has been lit 3000 hours. The lamp is operated with cyclic flushing periods, being lit for a period of 165 minutes, and then flushed for 15 minutes. The transformation period of 0.5 to 3.0 seconds is also controlled by the output voltage of an electronic ballast.

The metal halide includes one or more elements selected from a group of sodium (Na), scandium (Sc), lithium (Li), thallium (Tl), indium (In), and other rare earth elements; and the halogen used may be one or more elements selected from a group of fluorine (F), chlorine (Cl), bromide (Br), and iodide (I). The metal halide can control various characteristics, including emission color, general color rendering index (Ra), or efficiency of emission.

Mercury can control the amount of current flowing in the discharge vessel, by means of its vapor pressure. Other materials, having high vapor pressure and less emission, may be substituted for mercury. For example, aluminum halide.

The first connecting wire CC1, made of molybdenum, is arranged in parallel to the center axis of the outer bulb OB. One end of the first connecting wire CC1 is connected to the electrode 2A through the first conductor 3a. The other end of the first connecting wire CC1 is connected to the lead wire OCT1.

One end of the second connecting wire CC2, made of molybdenum, is connected to the electrode 2B through the second conductor 3b. The other end of the second connecting wire CC2 is connected to the lead wire OCT2.

Each of the first and second coils CO1, CO2, as a conductive member, made of molybdenum, is wound to the outer surface of the first and second tube portions 1b1, 1b2. Furthermore, one end of the first coil CO1 is connected to the second conductor 3b. One end of the second coil CO2 is connected to the first connecting wire CC1. The conductive member may be arranged to at least one of the first and second tube portions 1b1, 1b2. Also, the conductive member is connected to the electrode of the other tube portion so as to have the same electrical potential. Therefore, when a high frequency voltage is supplied to a pair of the electrodes, the same voltage is also supplied between the conductive member and the electrode of the other tube portion.

The conductive member is preferably closely placed to the outer surface of the tube portion by means of vacuum evaporation, coiling, painting, or adhesive. The coiling method is cheaper than any other methods. The conductive member, made by vacuum evaporation or painting, can shorten the distance to the electrode. Therefore, the conductive member operates adequately when the lamp starts to light. The conductive member may be formed into a shape of a coil, mesh, film, tube, or plate. When the conductive member is formed into a flat plate-shape, the distance between the conductive member and the electrode of the tube portion is equal at all points. Accordingly, the conductive member can operate adequately when the lamp starts to light.

Furthermore, the conductive member may be made of a conductive metal, e.g., molybdenum or niobium, or a conductive non-metal, e.g., carbon or a cermet.

The outer bulb OB, made of hard glass, is formed into tube shape. One end of the outer bulb OB is pinched and formed into a sealing portion ps, after the arc tube IB is inserted into the outer bulb OB. Moreover, after air of the outer bulb OB is evacuated through an exhaust tube (not shown) of the other end of the outer bulb OB, the exhaust tube is cut off and formed into an exhaust tip portion t. The outer bulb OB typically has an inner pressure of 5*10⁻³ Pa after evacuation. The air pressure of outer bulb OB may be 0.01 Pa or less.

Furthermore, the outer bulb OB may be made of quartz. The outer bulb OB can accommodate a supporting member to hold the arc tube IB. The first and second connecting wires CC1, CC2 may hold the arc tube IB for the supporting member. Also, conductor 3a, 3b may hold the arc tube IB for the supporting member.

When the first and second connecting wires CC1, CC2 are arranged in the outer bulb OB, a suitable distance between the discharge space portion 1a and the first connecting wire CC1 is in the range of 2 to 6 mm, and a suitable distance between the tube portion 1b1, 1b2 and the first connecting wire CC1 is in the range of 2 to 10 mm. For that range of parameters, an unsuitable discharge can not occur between the first connecting wire CC1 and the electrodes 2B.

Each of the lead wires OCT1, OCT2 extends from the outer bulb OB, and is connected to the lamp cap B. Moreover, the lead wires OCT1, OCT2 may be directly inserted into a socket (not shown).

The getter GT, made of an alloy including zirconium and aluminum, is welded to the first connecting wire CC1 in order to absorb impure gas in the outer bulb OB.

The lamp cap B (E11 type), having a screw terminal B1 and a tip terminal B2, is fixed to the sealing portion ps by an inorganic adhesive. An insulating distance between the screw and tip terminals is in the range of 4 to 6 mm, so that an insulation voltage is about 3 kV or less. In this invention, as the starting voltage of the high pressure discharge lamp is about 2 kV or less, the lamp can use the lamp cap B having an insulation voltage of about 3 kV or less. Accordingly, the high pressure discharge lamp can be utilized as an incandescent lamp.

The high pressure discharge lamp has a length between the tip of the lamp cap and the light center of the arc tube IB in the range of 47 to 51 mm. In this case, the length is the same as that of a halogen incandescent lamp.

The discharge vessel, provided with the spherical-portion la and tube portions 1b1, 1b2, has a total length of 23 mm, a maximum outer diameter of 6 mm, a maximum inner diameter of 5 mm, and a thickness of 0.5 mm. Each of tube portions 1b1, 1b2 has an outer diameter of 1.7 mm, an inner diameter of 0.8 mm, a thickness of 0.45 mm, and a length L2 of 8 mm.

Each electrode 2A, 2B, comprising the electrode rod and the coil, are made of tungsten.

Each conductor 3a, 3b, made of niobium, has an outer diameter of 0.75 mm.

The interspace (g) can be changed according to the outer diameter of the electrode rods 2a.

Each of the first and second metal coils CO1, CO2, formed by a molybdenum wire of about 0.3 mm diameter, has seven (7) turns, a pitch of 200%, and a total length (L1) of 5 mm. The ratio (L1/L2) is about 0.63.

The ionizable filling contains metal halide, mercury, and rare gases including neon and argon at a pressure of 26.6 kPa.

When the high pressure discharge lamp was supplied with a high frequency voltage of 47 kHz at a temperature of −20 degrees centigrade and dark brightness, the starting voltage was measured as follows:

TABLE 1

| | Starting voltage (kVp-p) |
|---|---|
| Interspace (g) (mm) | (Maximum value) |
| 0.25 | 4.0 |
| 0.20 | 3.3 |
| 0.15 | 2.8 |
| 0.10 | 1.6 |
| 0.05 | 1.1 |

According to TABLE 1, the starting voltage can be reduced in proportion to the interspace (g).

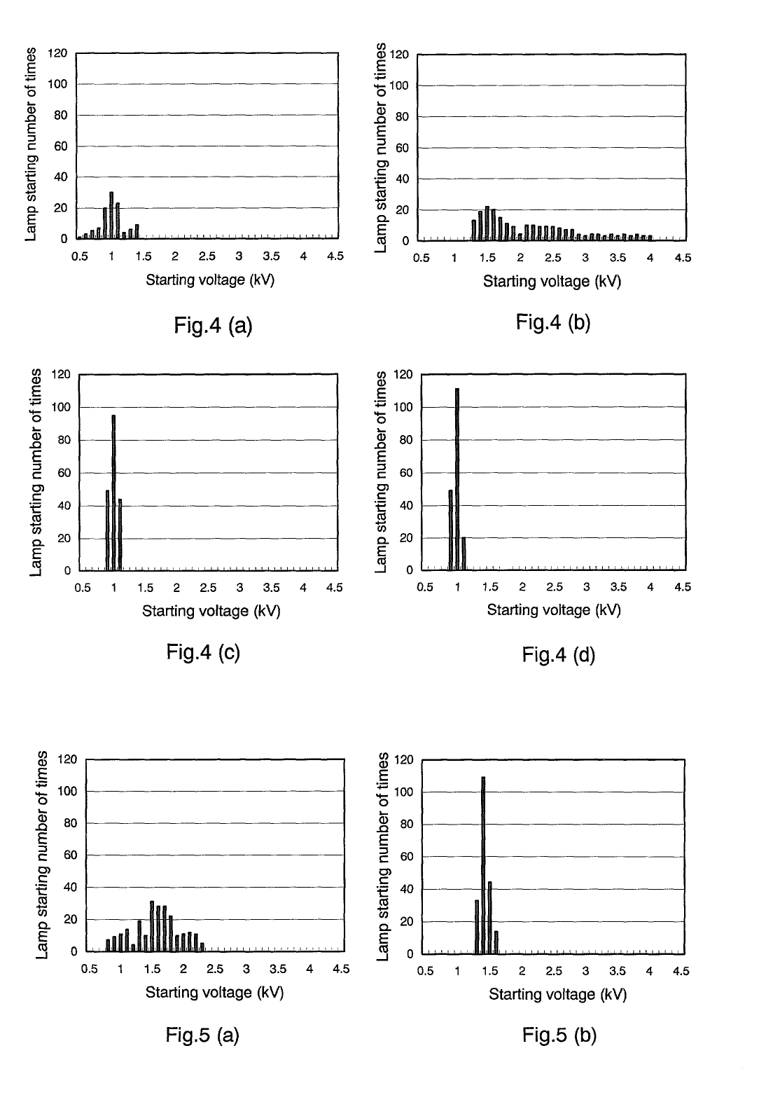

Furthermore, Comparative sample 1 is a high pressure discharge lamp having an interspace (g) of 0.25 mm. Example 1 is a high pressure discharge lamp having an interspace (g) of 0.05 mm. The other dimensions of Comparative sample 1 and Example 1 are the same as described above. For the high pressure discharge lamp of Comparative sample 1, supplied with a high frequency voltage of 47 kHz at a temperature of 25 degree centigrade, a histogram of the starting voltage is disclosed in FIG. 4(a). FIG.. 4(b) discloses a histogram for the starting voltage when the lamp of Comparative sample 1 was supplied with a high frequency voltage of 47 kHz at a temperature of −20 degrees centigrade and a condition of dark brightness.

When the high pressure discharge lamp of Example 1 was supplied with a high frequency voltage of 47 kHz at a temperature of 25 degrees centigrade, a histogram of the starting voltage resulted which is disclosed in FIG. 4(c). FIG. 4(d) discloses a histogram of the starting voltage when the lamp of Example 1 was supplied with a high frequency voltage of 47 kHz at a temperature of −20 degrees centigrade and a condition of dark brightness.

According to FIGS. 4(a) to (d), the starting voltages of Example 1 are in the narrow range of 0.9 to 1.1 kV as compared to that of Comparative sample 1, ranging from 0.5 to 4 kV. That is, when the interspace (g) is 0.1 mm or less, the starting voltage is decreased and does not fluctuate easily at a temperature of −20 degrees centigrade and a condition of dark brightness. Also, the high pressure discharge lamp of Example 1 can start without the igniter, because the starting voltage is 2 kV or less.

Furthermore, when the thickness of the tube portion is changed in the range of 0.75 to 0.25 mm, with an interspace (g) of 0.1 mm, the starting voltage (kVp-p) and the lamp starting time (second) was measured as follows:

TABLE 2

| | Starting voltage | |
|---|---|---|
| Thickness of tube | (kVp-p) | Lamp starting time |
| portion | (Maximum value) | (seconds) |
| 0.75 | 2.3 | 4.7 |
| 0.65 | 2.0 | 1.2 |
| 0.55 | 1.9 | 0.5 |
| 0.45 | 1.6 | 0.5 |
| 0.35 | 1.3 | 0.4 |
| 0.25 | | |

According to TABLE 2, the starting voltage and lamp starting time can be reduced in proportion to the thickness of the tube portion. The discharge vessel was broken when the thickness was 0.25 mm.

Furthermore, Comparative sample 2 is a high pressure discharge lamp having an interspace (g) of 0.1 mm and a tube portion thickness of 0.75 mm. Example 2 is a high pressure discharge lamp having an interspace (g) of 0.1 mm and a tube portion thickness of 0.45 mm. The other dimensions of Comparative sample 2 and Example 2 are the same as described above. For the high pressure discharge lamp of Comparative sample 2, supplied with a high frequency voltage of 47 kHz at a temperature of −20 degrees centigrade, a histogram of the starting voltage is disclosed in FIG. 5(a). FIG. 5(b) discloses a histogram of the starting voltage when the lamp of Example 2 was supplied with a high frequency voltage of 47 kHz in the same condition described above.

According to FIGS. 5(a) and (b), the starting voltages of Example 2 are in the narrow range of 1.3 to 1.6 kV as compared to that of Comparative sample 2, which ranges from 0.8 to 2.3 kV. That is, when the thickness of the tube portion is 0.35 to 0.65 mm, the starting voltage is decreased and does not fluctuate easily at a temperature of −20 degrees centigrade and in the condition of dark brightness. In this experiment, it takes 1.4 seconds at the first electrode 2A, and 1.6 seconds at the second electrode 2B to transform a glow discharge to an arc discharge.

When the thickness of the tube portion is less than 0.35 mm, a crack may occur at the tube portion due to the discharge impact. When the thickness is over 0.65 mm, heat capacity becomes excessive. Therefore, the temperature of a cold spot can not increase easily. As a result, the high pressure discharge lamp can not generate quickly.

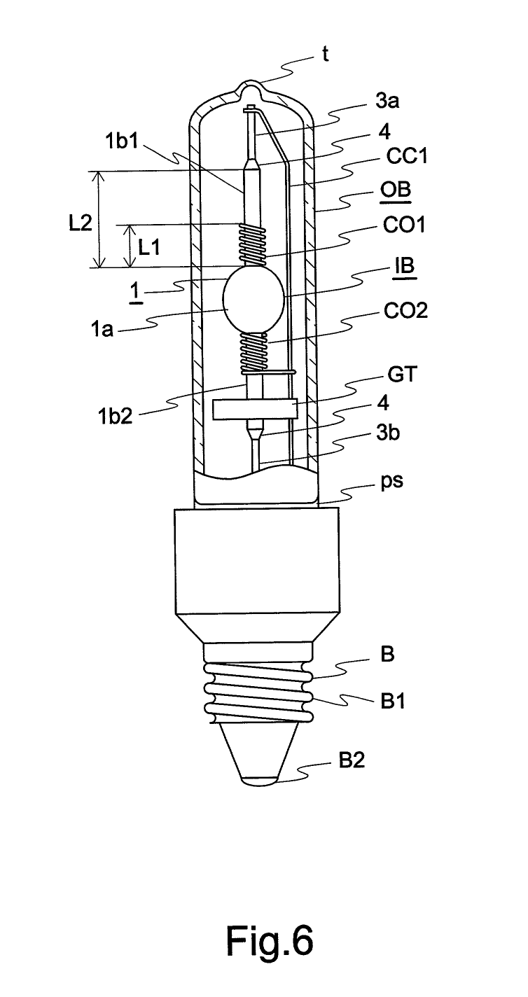

FIG. 6 shows a front view, partly in longitudinal section, of a high pressure discharge lamp according to a second embodiment of the present invention. The same reference characters designate identical or corresponding elements to the elements of the lamp shown in FIG. 1. Therefore, a detailed explanation of such a structure will not be provided.

In this embodiment, one end of first metal coil CO1, as a conductive member, made of molybdenum, is not electrically connected to a second conductor 3b joined with an electrode 2B (not shown in FIG. 6). That is, the first metal coil CO1 has a floating voltage electrically. When the interspace (g) is 0.1 mm or less, a starting voltage (maximum value) is 1.0 kVp-p. Furthermore, a period of transforming a glow discharge to an arc discharge is 0.7 seconds at the first electrode 2A, and 1.5 seconds at second electrode 2B. The electrostatic capacity between lead wires OCT1, OCT2 is in the range of about 1.8 to 2.0 pF.

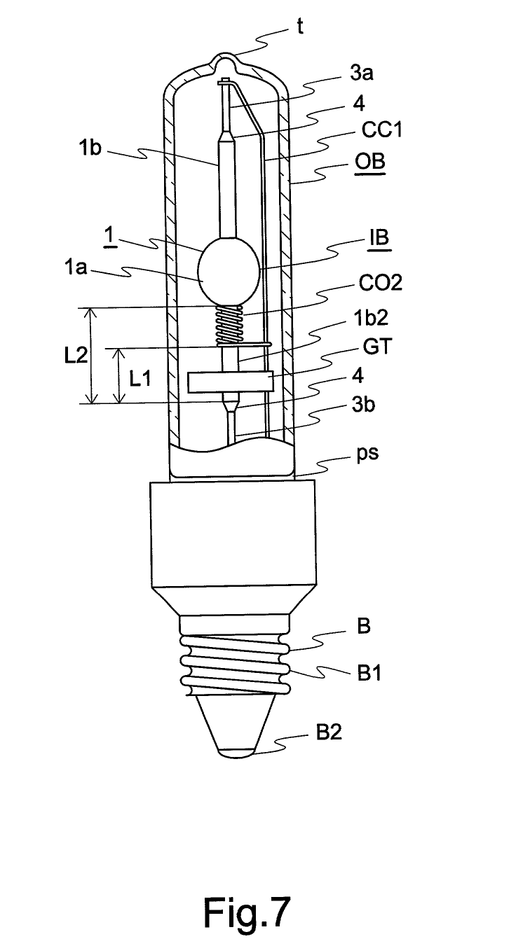

FIG. 7 shows a front view, partly in longitudinal section, of a high pressure discharge lamp according to a third embodiment of the present invention. The same reference characters designate identical or corresponding elements to the elements of the lamp shown in FIG. 1. Therefore, a detailed explanation of such a structure will not be provided.

In this embodiment, a discharge vessel IB only has a second metal coil CO2 as a conductive member. The second metal coil CO2 is electrically connected to a first conductor 3a joined with an electrode 2A (not shown in FIG. 7) through a first connecting wire CC1. When the interspace (g) is 0.1 mm or less, the starting voltage (maximum value) is 1.0 kVp-p. Furthermore, the period of transforming a glow discharge to an arc discharge is 0.6 seconds at the first electrode 2A, and 1.4 seconds at the second electrode 2B. The electrostatic capacity between lead wires OCT1, OCT2 is in the range of about 1.3 to 1.8 pF.

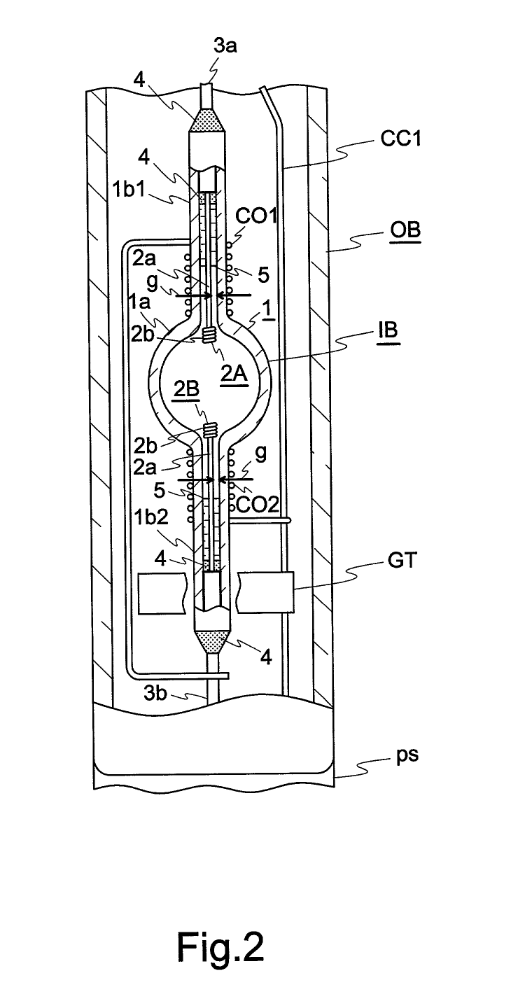

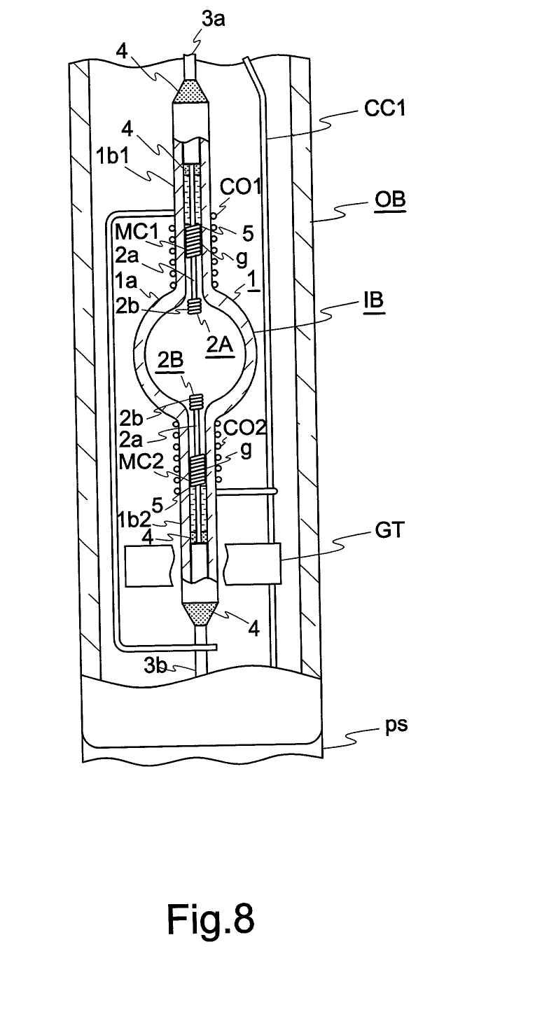

FIG. 8 shows an enlarged longitudinal section of a high pressure discharge lamp according to a fourth embodiment of the present invention. The same reference characters designate identical or corresponding elements to the elements of the lamp shown in FIG. 2. Therefore, a detailed explanation of such a structure will not be provided.

In this embodiment, a discharge vessel IB further comprises each of inner-conductive coils MC1, MC2, wound on the electrode rods 2a, respectively, in order to decrease the interspace (g). Each inner-conductive coil MC1, MC2, having eight (8) turns formed by a tungsten wire of 0.2 mm diameter, faces to the first and second metal coil CO1, CO2 respectively.

In case of using the inner-conductive coil MC1, MC2, the interspace (g) is defined as the distance from the outer surface of the coil MC1, MC2 to the inner surface of the tube portion 1b1, 1b2. In this embodiment, the interspace (g) is 0.05 mm. The inner-conductive coil MC1, MC2 also have a gap between coil turns.

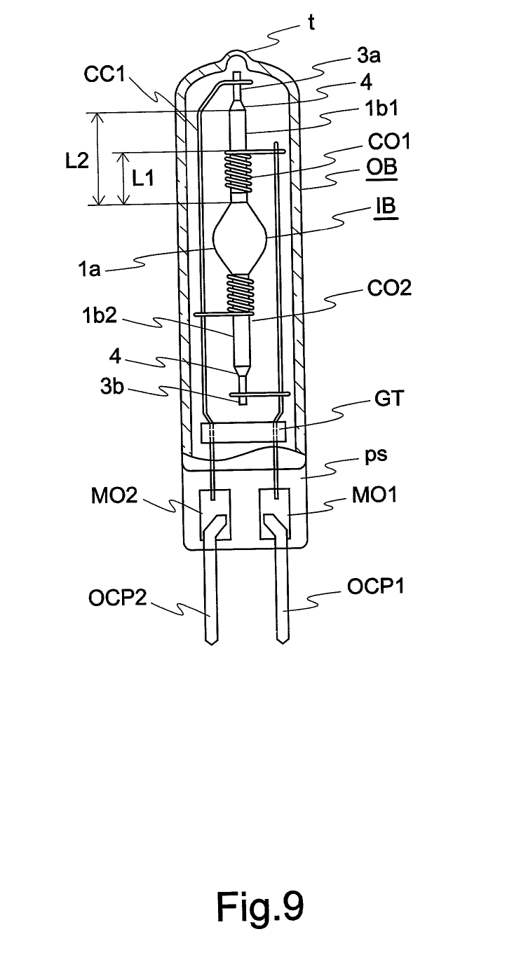

FIG. 9 shows a front view, partly in longitudinal section, of a high pressure discharge lamp according to a fifth embodiment of the present invention. The same reference characters designate identical or corresponding elements to the elements of the lamp shown in FIG. 1. Therefore, a detailed explanation of such a structure will not be provided.

The discharge vessel IB, provided with the elliptical-portion 1a and tube portions 1b1, 1b2, has a total length of 31.6 mm, a maximum outer diameter of 6 mm, a maximum inner diameter of 5 mm, and a thickness of 0.5 mm. Each of tube portions 1b1, 1b2 has an outer diameter of 1.7 mm, an inner diameter of 0.8 mm, a thickness of 0.45 mm, and a length L2 of 1.9 mm.

Each of first and second metal coils CO1, CO2, formed by a molybdenum wire of 0.2 mm diameter, has seven (7) turns, a pitch of 200%, and a total length (L1) of 5 mm. The ratio (L1/L2) is about 0.42. The other dimensions and an ionizable filling of the discharge vessel IB are the same as the first embodiment.

In this embodiment, each of molybdenum foils MO1, MO2, which is connected to a first and second connecting wires CC1, CC2 respectively, is embedded in a sealing portion ps of an outer bulb made of quartz. Each molybdenum foil MO1, MO2 is also connected to lead pins OCP1, OCP2, extending from the discharge vessel IB. The lead pins OCP1, OCP2 are connected to a pin type socket (not shown).

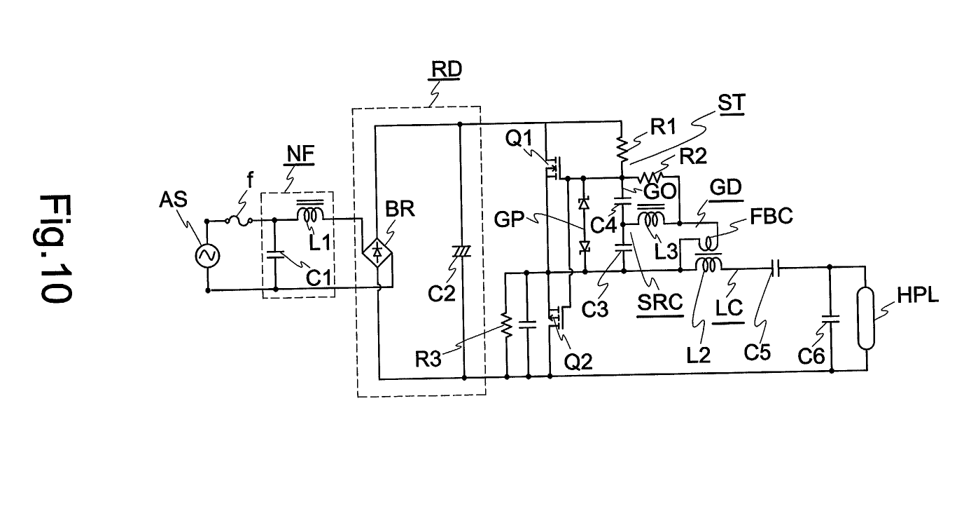

FIG. 10 shows a circuit diagram of an electronic ballast for a high pressure discharge lamp of the present invention.

The electronic ballast for a high pressure discharge lamp employs an alternating current power supply AS of 1000V. A fuse f is formed on a circuit board.

A noise filter NF, including a capacitor C1 and an inductor L1, is connected between the power supply AS and a rectified direct current power source RD. The noise filter NF reduces noise generated by the switching of a pair of switching elements Q1, Q2.

The rectified direct current power source RD includes a full-wave rectification circuit BR connected to a smoothing capacitor C2.

A first switching element Q1, e.g., an N-channel enhancement mode MOSFET, has a terminal, e.g., a drain, connected to a positive side of the smoothing capacitor C2. A second switching element Q2, e.g., a P-channel enhancement mode MOSFET, has terminals, e.g., a drain, connected to a negative side of the smoothing capacitor C2, and a source, connected to a source of the first switching element Q1. Accordingly, the first and second switching elements Q1, Q2 are capacitively connected to each other, and can generate a high-frequency alternating current for a load circuit LC. That is, when a drive voltage from a gate drive circuit GD is provided between the gate and source of each MOSFET at the same time, the N-channel MOSFET turns on when the supplied voltage is positive, and the P-channel MOSFET turns on when the supplied voltage is negative. If the drive signal is not supplied, both MOSFETS remain OFF. Such being the case, the MOSFETS are turned on alternately. As a result, the drive circuit becomes simple, so that the ballast using the drive circuit can be compact.

The gate drive circuit GD includes a feedback circuit FBC, a series resonance circuit SRC, and a gate voltage output circuit GO.

The feedback circuit FBC includes an auxiliary inductor coupled to a current-limiting inductor L2 magnetically.

The series resonance circuit SRC comprises a series circuit, including a capacitor C3 and a resonance inductor L3, connected to the feedback circuit FBC.

The gate voltage output circuit GO supplies a resonance voltage between the gate and source of the switching elements Q1, Q2. The capacitor C4 is arranged between the gates of the switching elements Q1, Q2 and a connecting point of capacitor C3 and the inductor L3. Furthermore, the opposite end of the connecting point of capacitor C3 is connected to the source of the switching elements Q1, Q2.

A starting circuit ST, including three resistors R1, R2, and R3, is connected in series with the rectified direct current power source RD. One end of the resistor R1 is connected to the positive side of the smoothing capacitor C2, and the other end thereof is connected to a junction of the gate of the first switching element Q1 and one end of the capacitor C4. The other end of the resistor R2 is connected to a connecting point of the inductor L2 and the feedback circuit FBC. One end of the resistor R3 is connected to a connecting point of the first and second switching element Q1, Q2. Also, the other end of the resistor R3 is connected to the negative side of the smoothing capacitor C2.

The gate protection circuit GP, connected in parallel to the gate voltage output circuit GO, clamps the gate-to-source voltage to a limit determined by the voltage ratings of the back-to-back Zener diodes.

The load circuit LC is provided with a resonance capacitor C6 connected in parallel to an aforementioned high pressure discharge lamp HPL, and a series resonance circuit, including the inductor L2, a capacitor C5 for cutting off direct current, and the high pressure discharge lamp HPL.

An operation of the above-mentioned circuit will be explained hereinafter. A direct current voltage from the rectified direct current power source RD is supplied to the smoothing capacitor C2, when the alternating current power supply AS turns on. The direct current voltage is smoothed by the smoothing capacitor C2. The smoothed direct current voltage is supplied between the drain and source of the first and second switching elements Q1, Q2 respectively.

At this time, the first and second switching elements Q1, Q2 are off, because no voltage is supplied to the gates thereof. Furthermore, the rectified direct current power source RD also supplies the direct current voltage to the starting circuit ST, so that a voltage drop occurs across each resistor. As a result, the capacitor C4 is charged by the voltage drop across the resistor R2. Moreover, the voltage drop is supplied between the gates and sources of the switching elements Q1, Q2 respectively. When the voltage drop across the resistor R2 is supplied to the gate of the first switching element Q1, the first switching element Q1 turns on. However, the second switching element Q2 is still off, because a negative voltage is supplied to the gate thereof.

When the first switching element Q1 turns on, the direct current of the rectified direct current power source RD flows through a path, including the positive side of the rectified direct current power source RD, the drain and source of the first switching element Q1, the inductor L2, the load circuit LC, the resonance capacitor C6, and the negative side of the rectified direct current power source RD. At the same time, the series resonance circuit, having the resonance inductor L2, the capacitor C5, and the resonance capacitor C6 resonates, so that a voltage of the resonance capacitor C6 can increase and also be supplied to the high pressure discharge lamp HPL.

Furthermore, the current flowing into the inductor L2 induces a voltage in the feedback circuit FBC in proportion to the current of the load circuit LC. The induced voltage in the feedback circuit FBC resonates to the series resonance circuit SRC, so that this resonance voltage can continuously be supplied between the gate and source of each of the first and second switching elements Q1, Q2. At this time, the gate protection circuit GP clamps the gate-to-source voltage to a limited resonance voltage, determined by the voltage ratings of the back-to-back Zener diodes. Therefore, the first switching element Q1 maintains on. However, the second switching element Q2 is still on, because the negative of the above-mentioned resonance voltage is supplied between the gate and source of the second switching element Q2.

The resonance voltage of the series resonance circuit SRC is inverted to the opposite polarity during the next half cycle of the resonance voltage. Therefore, the gate-to-source voltage of the first switching element Q1 changes to a negative value, so that the first switching element Q1 turns off. Then, the second switching element Q2 turns on, because the gate-to-source voltage of the second switching element Q2 reverses to a positive voltage. Accordingly, the electrostatic capacitance of the capacitor C3 of the series resonance circuit SRC and the inductor L2 can control an on term of the first switching element Q1.

When the first switching element Q1 turns off, the electromagnetic energy, stored in the resonance inductance L2, is released as a current. The current flows through a path, including the second switching element Q2, the resonance capacitor C6, the capacitor C5, the resonance inductor L2. When this current has gone, an electrical charge of the resonance capacitor C6 discharges through an opposite path, including a diode (not shown) of the second switching element Q2, the resonance inductor L2, the capacitor C5, and the resonance capacitor C6.

In this time, the induced voltage in the feedback circuit FBC resonates in the series resonance circuit SRC, so that the resonance voltage can continuously be supplied between the gate and source of each of the first and second switching elements Q1, Q2. At this time, the gate protection circuit GP clamps the gate-to-source voltage to a limited resonance voltage, determined by the voltage ratings of the back-to-back Zener diodes. Therefore, the second switching element Q2 maintains on.

The resonance voltage of the series resonance circuit SRC is inverted to the other polarity during the next half-cycle of the resonance.

Accordingly, after the electromagnetic energy stored in the resonance inductor L2 is released, once more, the rectified direct current power source RD supplies current to load circuit LD. The above-mentioned operation of the half-bridge inverter continues to repeat.

The above-mentioned voltage of the resonance capacitor C6, which is supplied to the high pressure discharge lamp HPL the load circuit LD, can be controlled by an operational frequency of the inverter circuit including the first and second switching elements Q1, Q2. When the operational frequency of the inverter closes to the resonance frequency of the load circuit LD, the resonance voltage increases and approaches the discharge starting voltage of the high pressure discharge lamp. After the lamp starts to light, the resonance voltage is decreased by reducing the operational frequency of the inverter.

Furthermore, when the high pressure discharge lamp HPL is unloaded, the inductor L2 of the load circuit LD decreases, so that the inductance of the load circuit LD decreases. The inverter circuit outputs at a constant frequency.

According to the above-mentioned electronic ballast, it is set up so that a secondary release voltage V2 of about 500V (effective value), or about 1.0 kVp-p (peak to peak value), is generated which is greater than the starting voltage. The ratio V2/Vs (%) of the secondary release voltage V2 and aforementioned discharge starting voltage Vs is in the range of 110 to 300%.

The electronic ballast, including an inverter circuit, may supply a high frequency voltage of 10 to 200 kHz to the high pressure discharge lamp. When the high pressure discharge lamp is supplied with a high frequency voltage of 10 to 200 kHz, the equivalent electrostatic capacity of the tube portion increases. Therefore, it is easy to generate a fore-discharge between the conductive member and the electrode.

After the high pressure discharge lamp HPL begins to generate a glow discharge, the glow discharge transforms to an arc discharge during four (4) seconds, so that the lamp lights stably. As the transforming period is suitable, it is difficult for the lamp to blacken. Moreover, a secondary short-circuit current is about 550 mA. As this amount of the secondary short-circuit current is small, even if the high pressure discharge lamp HPL breaks, the current does not leak easily. The above electronic ballast may be used an electronic ballast for a fluorescent lamp.

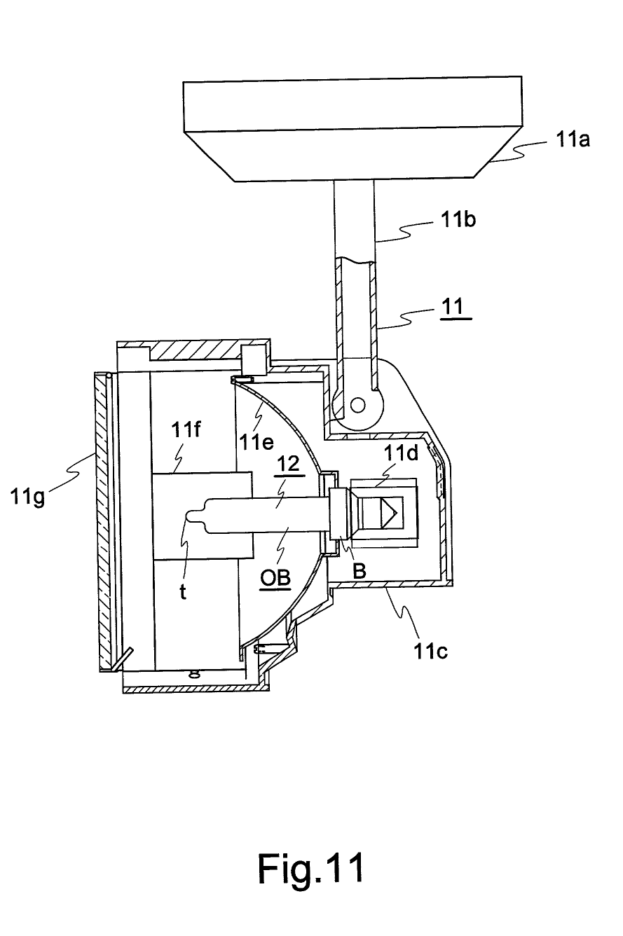

FIG. 11 shows a longitudinal section of a spotlight using the above-mentioned lamp according to a lighting apparatus of the present invention.

A spotlight is provided with a housing 11 and a high pressure discharge lamp 12 accommodated therein.

The housing 11 comprises a base 11a adapted to be fixed to a ceiling, an arm 11b held by the base 11a,a case 11c accommodating the high pressure discharge lamp 12, a lamp socket 11d, a reflector 11e, a shade 11f, and a front glass 11g.

The base 11a and arm 11b has cables therein to electrically connect the high pressure discharge lamp 12 to a electronic ballast fixed in the ceiling or the base 11a.

The case 11c is attached to one end of the arm 11b so as to be able to rotate itself.

The lamp socket 11d, arranged in the case 11c, can adapt to a screw base of E11 type. The reflector 11e is fixed in front of the socket 11d, and accommodates the high pressure discharge lamp 12. The shade 11f covers a front part of the high pressure discharge lamp 12, so that glaring light from the lamp 12 can be cut off. Furthermore, the front glass 11g is fixed to cover the front of the case 11c. Accordingly, even if the high pressure discharge lamp 12 is broken, pieces of glass are not scattered outwardly.

The lighting apparatus may be a lighting fixture, a vehicle headlight, a projector, or a lighting device for photo-chemistry.

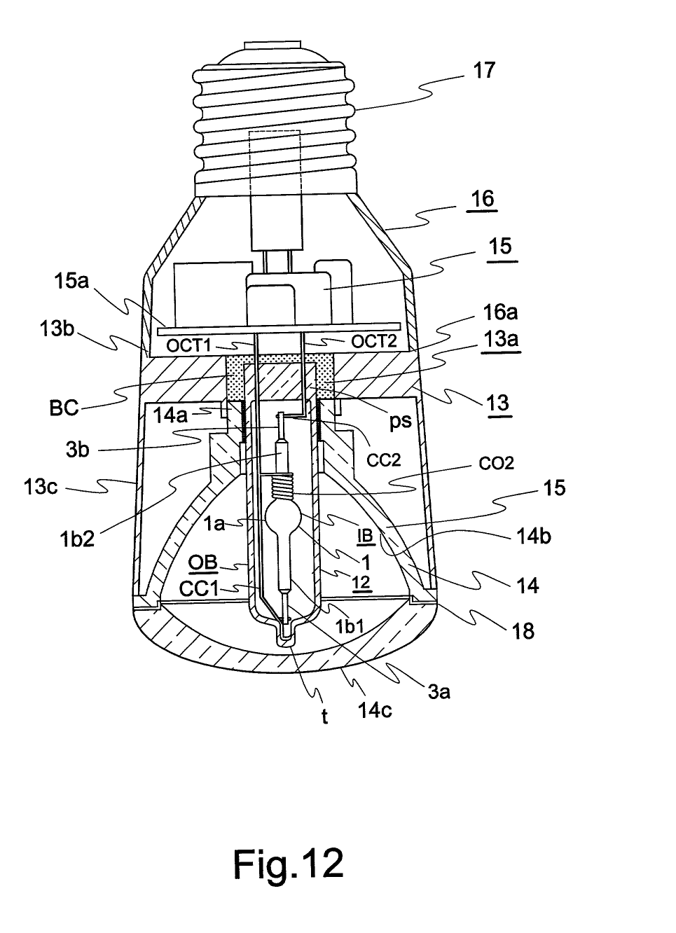

FIG. 12 shows a longitudinal section of a high pressure discharge lamp device according to a lighting apparatus of the present invention.

A high pressure discharge lamp device is provided with a high pressure discharge lamp 12, a base 13, a reflector 14, an electronic ballast 15, a case 16, and a lamp cap 17 of screw base. Accordingly, this high pressure discharge lamp device can be used for an incandescent lamp. The high pressure discharge lamp 12 is the same lamp shown in FIG. 5.

The same reference characters designate identical or corresponding elements to the elements of the lamp shown in FIG. 5. Therefore, a detailed explanation of such a structure will not be provided.

The base 13, made of heat synthetic resin, includes a lamp holding portion 13a, a joint portion 13b, and a surrounding portion 13c.

The lamp holding portion 13a fixes the sealing portion ps of the high pressure discharge lamp 12, and a neck portion 14a of the reflector 14, using an inorganic adhesive BC. Furthermore, the lamp holding portion 13a is fixed to an opening end of the case 16. The surrounding portion 13c encloses the reflector 14, having a vapor deposition film 14b made of aluminum, accommodating the high pressure discharge lamp 12. The reflector 14 also fixes a front glass 14c at an opening thereof using glass having a low melting point. Moreover, a space, constructed by the reflector 14 and front glass, is filled with nitrogen as an inert gas.

The electronic ballast 15, arranged on an upper surface of a circuit board 15a according to the FIG. 12, is accommodated to the case 16 having the lamp cap 17 of E (Edison) 26 type. Terminals (not shown), formed at the opposite surface to the upper surface having the electronic ballast 15, are respectively connected to lead wires OCT1, OCT2 extending from the outer bulb OB.

A circuit diagram of the electronic ballast 15 is the same as the circuit diagram shown in FIG. 6.

What is claimed is:

1. A high pressure discharge lamp comprising:
an arc tube comprising:
a light-transmitting discharge vessel, made of ceramics, including a discharge space portion filled with an ionizable filling, and a pair of tube portions, of which the inner diameter is smaller than that of the discharge space portion, continuously formed from the discharge space portion;
each of electrodes, arranged in the tube portions, wherein a minimum interspace between the outer surface of the electrode and the inner surface of the tube portion is 0.1 mm or less;
a conductive member, arranged to at least one of the tube portions, and connected electrically to the electrode of the other tube portion; and
an outer bulb, enclosing the arc tube.

2. A high pressure discharge lamp according to claim 1, further comprising:
a lamp cap, including a screw member having its outer diameter of 8 to 12 mm, fixed to the outer bulb.

3. A high pressure discharge lamp according to claim 1, wherein a thickness of the tube portion is in the range of 0.35 to 0.65 mm at the place of the conductive member.

4. A high pressure discharge lamp according to claim 1, further comprising:
an electronic ballast, including an inverter circuit, supplying a high frequency voltage of 10 to 200 kHz to the high pressure discharge lamp.

5. A lighting apparatus comprising:
a housing; and
a high pressure discharge lamp comprising:
an arc tube comprising:
a light-transmitting discharge vessel, made of ceramics, including a discharge space portion filled with an ionizable filling , and a pair of tube portions, of which inner diameter is smaller than that of the discharge space portion, continuously formed from the discharge space portion;
each of electrodes, arranged in the tube portions, wherein a minimum interspace between the outer surface of the electrode and the inner surface of the tube portion is 0.1 mm or less; and
a conductive member, arranged to at least one of the tube portions, and connected electrically to the electrode of the other tube portion; and
an outer bulb, enclosing the arc tube; and
an electronic ballast, including an inverter circuit, supplying a high frequency voltage of 10 to 200 kHz to the high pressure discharge lamp.
